(19) United States
(12) Patent Application Publication
(10) Pub. No.: US 2026/0103843 A1
(43) Pub. Date: Apr. 16, 2026

(54) A METHOD FOR REDUCING THE LOAD OF MICROBIAL CONTAMINANTS IN A PULP STOCK COMPRISING A RECYCLED FIBER FRACTION

(71) Applicant: Stora Enso OYJ, Helsinki (FI)

(72) Inventor: Atso Laakso, Varkaus (FI)

(73) Assignee: Stora Enso OYJ, Helsinki (FI)

(21) Appl. No.: 19/116,069

(22) PCT Filed: Sep. 21, 2023
(86) PCT No.: PCT/IB2023/059335

§ 371 Date: Mar. 27, 2025

(30) Foreign Application Priority Data
Sep. 27, 2022 (SE) 2230313-5

(51) Int. Cl. D21H 21/36; D21C 5/02; D21H 17/05; D21H 17/64; D21H 23/10

(52) U.S. Cl. CPC D21H 21/36; D21C 5/02; D21H 17/05; D21H 17/64; D21H 23/10

(57) ABSTRACT

The present invention relates to a method for reducing the load of microbial contaminants in a pulp stock comprising a recycled fiber fraction, said method comprising the following steps performed in sequence: a) providing a pulp stock comprising a recycled fiber fraction at a consistency in the range of 2-10 wt % in water; b) adding a basic oxide selected from the group consisting of calcium oxide (CaO) and sodium oxide (Na2O) to the pulp stock and allowing the basic oxide to react with water to form the corresponding hydroxide, wherein the amount of the basic oxide added is sufficient to raise the pH value of the pulp stock to above 12.5 and to maintain the pH value of the pulp stock above 12.5 for at least 60 minutes; c) allowing the pulp stock to remain at a pH value above 12.5 for at least 60 minutes; and d) adding an organic oxidative acid to the pulp stock, wherein the amount of the organic oxidative acid added is sufficient to reduce the pH value of the pulp stock to below 10.

### TECHNICAL FIELD

The present disclosure relates to methods for recycling a fiber fraction from used beverage carton (UBC). More specifically, the present disclosure relates to methods for reducing the load of microbial contaminants in recycled UBC fiber fractions.

### BACKGROUND

The multilayer construction of beverage cartons provides a resource efficient, lightweight and recyclable packaging solution that can be made from renewable resources. Sustainably sourced virgin cellulose fibers provide strength and stiffness whilst the other layers provide barriers to liquid, water vapor, oil/grease, oxygen and light to protect the packed contents. The correct combination of materials ensures food transport and storage safety, while preventing food spoilage and waste by protecting the contents from deterioration. These barrier layers may consist of various polymers or a combination of polymers and aluminum foils or coatings, depending on the type of product to be packaged, and whether the product is kept refrigerated or if it is distributed and stored at room temperature.

Beverage carton in its simplest form comprises at least one paperboard layer and at least one liquid barrier layer, typically a polyolefin layer. Beverage carton may further comprise an additional barrier layer, typically an aluminum foil or coating layer, or a high barrier polymer layer such as polyamide or EVOH. Such beverage carton is often used for aseptic packaging and is therefore often referred to as aseptic beverage carton.

The typical structure of an aseptic carton includes a polyolefin, typically LDPE (low density polyethylene), outer layer which provides a moisture and liquid barrier, protects the printing ink layer applied to the board and enables the package to be heat sealed. The type of paperboard used depends on the product being packed, the market where it will be sold and the manufacturing conditions, but it is commonly a two or three ply or even up to five ply material with a bleached or clay-coated outer layer and often contains CTMP (chemithermomechanical pulp), TMP (thermomechanical pulp), brown pulp or high yield pulp; the paperboard gives the package the required mechanical rigidity and typically represents about 65-75% of the total weight of the package. The inner side of the paperboard is coated with LDPE to tie it to the aluminum foil layer that provides an odor, light, and gas barrier. Adhesion of the aluminum foil to the innermost plastic layer is achieved through the use of a tie layer, e.g. of EMAA (poly(ethylene-co-methacrylic acid). Finally, an inner layer of LDPE is applied to enable heat sealing of the carton.

The term used beverage carton (UBC) is used herein to denote post-consumer beverage carton, and particularly post-consumer aseptic beverage carton, obtained from containers and packaging materials which have been collected after being used.

The composition of UBC is different compared to many other recycled sources. UBC is typically characterized by:
High amount of bleached or unbleached chemical, semi-chemical, or mechanical fibers
High plastic content
High content of aluminum from foils and coatings
Food or liquid residues
High microbe (microorganism) content
High amount of organic materials including different fats and oils
High content of single and multivalent ions or salts
Possible presence of heavy metals
Non-intentionally added substances (NIAS)
Mixed waste containing packaging and packaging items such as single use components (caps, straws and long stringy materials such as baling wire, etc)

Recycling can be categorized as primary, secondary, tertiary, and quaternary recycling. Primary recycling refers to reprocessing the material back into its original use or comparable products with equivalent or higher quality, but this is currently not an option for post-consumer cartons as they cannot be directly converted back into their original use. Secondary recycling, wherein materials are processed and used in applications not requiring virgin material properties is the most widespread recycling option for UBC. The paper fibers are separated from the polymer and aluminum residual (also referred to herein as the PolyAl residual) and the fibers are incorporated into paper products. Another secondary recycling process involves converting the shredded UBC into construction materials. Tertiary recycling involves breaking a product down into its chemical building blocks, and then recycling those chemicals into various products. Quaternary recycling of UBC involves incineration with energy recovery, although this process is not considered as recycling in many countries.

Due to its multilayer structure and characteristic composition, it is difficult to efficiently recycle and reuse UBC. As a result, UBC is today often collected and then either disposed as landfill, burned or processed into different lower value fractions (e.g. a polymer-rich fraction, a fiber-rich fraction, and a waste water or sludge fraction). The fiber-rich fraction is typically used in composite materials, non-food packaging applications and other grades where higher contents of impurities are tolerated, such as tissues, towels, liner and writing paper.

As the paperboard typically constitutes 65-75% of the total weight of the carton, recovery of this fraction has been the predominant focus of carton recycling approaches. Recycling may be accomplished at a paper mill by recovering the paper fibers using a conventional hydrapulper or a drum pulper. Hydrapulpers are large cylindrical vessels with impellers at the bottom which break apart the paper fibers and produce a relatively dilute slurry of fibers that can be further processed within the mill. Contact between the water and the paper layer occurs in the hydrapulper, and the layers separate due to the hydraulic forces inside the pulper. No chemicals are required, but solvents or acid or alkaline solutions may sometimes be used to improve the separation efficiency. The consistency of the pulp in the hydrapulper is typically below 15 wt %. Hydrapulpers are generally equipped with a ragger which removes the PolyAl residual, caps, straws and long stringy materials such as baling wire from the slurry. After removal from the pulper, the PolyAl residual is washed in a perforated rotating cylinder to recover any entrained fibers. A drum pulper is basically a rotating, inclined drum with baffles, which separates the debris from the fibers in pulping and screening sections with minimal fiber loss.

The high amounts of impurities in recovered UBC fibers, particularly from food residues and non-intentionally added substances (NIAS), can make them unsuitable for mixing into virgin or less contaminated pulp streams. Today, there are strict regulations and limitations on the use of recycled material in paperboard manufacturing processes. Fibers obtained from UBC may contain components that should not be allowed back into a paperboard making process. Examples include plastic particles, metals metal compounds, optical brightening agents (OBA) or fluorescent whitening agents (FWA), ink residuals or mineral oils, and in particular microbes, toxic components, and food residues. These impurities can interfere with wet end chemistry (process performance), but also end product properties (mechanical or product performance, barrier properties, impurities, microbial growth, etc.).

Fibers obtained from UBC may often exhibit high microbial activity, or high microbial load, and microbial deactivation or sterilization of the fibers or pulps is typically required before they can be reused.

Generally, only virgin paper fibers are used in the manufacture of paperboard for food or beverage packaging applications. There is a need to increase the amount of recycled fiber content in paperboard for food packaging applications. Due to the high degree of contamination, microbial load, and downgrading of the recycled material it is commonly assumed that fibers from UBC cannot be efficiently reused in food or beverage packaging laminates or products.

Thus, there is a need to find methods that allow pulp from UBC to be used in food or beverage packaging substrates and laminates, especially in higher contents, without affecting mechanical properties of the substrates and laminates or causing risks for contamination of packaged contents.

### DESCRIPTION OF THE INVENTION

It is an object of the present disclosure to provide a method that allows pulp stock having a high microbial load, such as pulp stock obtained from used beverage carton (UBC), to be reused in applications and products where typically only virgin paper fibers are used, such as in food or beverage packaging substrates and laminates.

It is an object of the present disclosure to provide a used fiber fraction, such as a fiber fraction obtained from UBC, which has suitable or required biological purity for being reused in food or beverage packaging substrates and laminates.

It is an object of the present disclosure to provide a method for reducing the load of microbial contaminants in a pulp stock comprising a recycled fiber fraction.

The above-mentioned objects, as well as other objects as will be realized by the skilled person in the light of the present disclosure, are achieved by the various aspects of the present disclosure.

The present invention is based on the realization that subjecting pulp stock having a high microbial load, such as pulp stock obtained from used beverage carton (UBC), to treatment with a basic oxide at elevated pH followed by reduction of the pH by addition of an organic oxidative acid.

According to a first aspect illustrated herein, there is provided a method for reducing the load of microbial contaminants in a pulp stock comprising a recycled fiber fraction, said method comprising the following steps performed in sequence:
a) providing a pulp stock comprising a recycled fiber fraction at a consistency in the range of 2-10 wt % in water;
b) adding a basic oxide selected from the group consisting of calcium oxide (CaO) and sodium oxide (Na₂O) to the stock and allowing the basic oxide to react with water to form the corresponding hydroxide, wherein the amount of the basic oxide added is sufficient to raise the pH value of the pulp stock to above 12.5 and to maintain the pH value of the pulp stock above 12.5 for at least 60 minutes;
c) allowing the pulp stock to remain at a pH value above 12.5 for at least 60 minutes; and
d) adding an organic oxidative acid to the pulp stock, wherein the amount of the organic oxidative acid added is sufficient to reduce the pH value of the pulp stock to below 10.

The term pulp stock as used herein generally refers to an aqueous dispersion comprising pulp fibers. In addition to the pulp fibers, the pulp stock may also comprise other dispersed or dissolved components.

The treated pulp stock obtained according to the inventive method is preferably suitable for demanding end uses such as for direct or indirect food contact. The method has been found to not only lead to a sufficient reduction of the load of microbial contaminants in a pulp stock comprising a recycled fiber fraction, but also to do so while maintaining the mechanical properties of paperboard prepared from the pulp stock at an acceptable level. Specifically, it has been found that with the inventive method, the load of microbial contaminants can be significantly reduced, while the elastic modulus, the tensile strength index, the TEA index, and/or the tensile stiffness index of isotropic sheets formed from the treated pulp stock is substantially retained.

The recycled fiber fraction of the pulp stock provided in step a) may be any cellulose based fiber fraction which has been previously used and which has or may have a microbial load which makes the based fiber fraction less suitable for being reused in the manufacture of paperboard for food packaging applications. One type of recycled fiber fraction which is of particular interest for use with the inventive method is pulp obtained from used beverage carton (UBC). Thus, in some embodiments, the recycled fiber fraction comprises fibers obtained from UBC.

In addition to cellulose fiber, used UBC also comprises a high content of plastic materials, mainly polyolefins, and a high content of aluminum from foils and/or coatings. In some embodiments the UBC comprises at least 15 wt %, and in some embodiments at least 20 wt % of plastic, based on dry weight. In some embodiments the UBC comprises at least 0.3 wt %, and preferably at least 1 wt % of aluminum or aluminum compounds, based on dry weight. In some embodiments the UBC comprises at least 15 wt % plastic and at least 0.3 wt % aluminum or aluminum compounds preferably at least 20 wt % plastic and at least 1 wt % aluminum or aluminum compounds, based on dry weight.

In order to obtain a fiber fraction suitable for reducing the load of microbial contaminants in accordance with the inventive method, plastics and/or aluminum content is first removed from a UBC starting material. This is typically done by subjecting the UBC starting material to a polymer and aluminum film separation method to obtain a UBC polymer and aluminum fraction and a raw UBC fiber fraction. If the UBC starting material does not contain aluminum, the UBC polymer and aluminum fraction may only comprise polymer and no aluminum. The obtained UBC fiber fraction is mainly comprised of cellulosic material and comprises significantly less plastics and aluminum than the UBC starting material. The polymer and aluminum film separation method may comprise shredding the UBC starting material and mixing the shredded UBC starting material with water or an aqueous solution. As the mixture is stirred, the fibers absorb moisture and the plastic and aluminum layers of the laminate are loosened. Through mechanical filtration and/or flotation, various fractions are separated to obtain a UBC polymer and aluminum fraction and a UBC fiber fraction.

The recycled fiber fraction comprises at least 70 wt % cellulose fiber, based on dry weight. In some embodiments, the fiber fraction recycled comprises at least 80 wt % cellulose fiber, based on dry weight.

The pulp stock comprising the recycled fiber fraction should be provided at a consistency in the range of 2-10 wt % in water. If the consistency of the pulp stock is too low, it can be raised by dewatering. If the consistency of the pulp stock is too high, it can be lowered by dilution with water.

The pulp stock in provided in step a) typically has a pH value below neutral. For example, a UBC fiber fraction will typically have a pH value of about 5. In some embodiments, the pulp stock in a) has a pH value below 7. Unless specified otherwise, the pH values are determined according to standard SCAN P 48:83.

The pulp stock in provided in step a) typically has a negative redox potential value. In some embodiments, the pulp stock in a) has a redox potential value below −100 mV. Unless specified otherwise, the redox potential is determined using an electrode which is calibrated with a commercial standard solution.

ATP has been adopted widely in the food industry as a molecule that can be used to indirectly detect the presence of microbes. As the level of ATP produced by all bacterial cells is approximately the same, measuring ATP provides an indication of the numbers of bacterial cells present in a sample. ATP is quantified by measuring the light, in RLU (relative luminescence units), produced through its reaction with the naturally occurring firefly enzyme luciferase using a luminometer. The amount of light produced is directly proportional to the amount of ATP present in the sample. The microbial load of the pulp stock may for example be represented by the enzymatic activity of the fiber fraction measured by RLU (relative luminescence units). In some embodiments, the pulp stock in a) has an enzymatic activity measured by RLU (relative luminescence units) above 100 000, preferably above 300 000, and more preferably above 500 000.

The RLU value can also be converted to a corresponding microbial equivalent content. Thus, the microbial load of the pulp stock may also be represented by the microbial equivalent (ME) content of the fiber fraction. In some embodiments, the pulp stock in a) has a microbial equivalent content of above 1×10⁶ ME/ml, preferably above 1×10⁷ ME/ml.

The microbial load of the pulp stock may also be assessed by counting colony forming units (CFU) on plates. In some embodiments, the pulp stock in a) has a total colony forming unit count of above 60 000 CFU/ml, typically above 70 000 CFU/ml.

The pulp stock comprising the recycled fiber fraction is subjected to a method for reducing the load of microbial contaminants therein. This method for reducing the load of microbial contaminants may also be referred to as a deactivation method. The terms reducing the load of microbial contaminants, or deactivation, as used herein refers to a method or treatment which reduces the microbial activity or microbial load of the pulp stock. The method kills or deactivates microorganisms and other potential pathogens present in the pulp stock. The method may lead to a complete sterilization or a partial deactivation, i.e. a disinfection or a sanitization, of the pulp stock.

The method for reducing the load of microbial contaminants preferably reduces the microbial activity of the pulp stock by at least 30%, preferably at least 40%, at least 50%, or at least 60%, such as in the range of 60-100%. Preferably, the method reduces the microorganisms and other potential pathogens present in the pulp stock to a level which is normally accepted for fibers for use in food or beverage packaging substrates and laminates. The treated pulp stock preferably has suitable biological purity, and suitable mechanical properties for being reused in food or beverage packaging substrates and laminates.

The method comprises adding a basic oxide selected from the group consisting of calcium oxide (CaO) and sodium oxide (Na₂O) to the pulp stock and allowing the basic oxide to react with water to form the corresponding hydroxide, i.e. calcium hydroxide and sodium hydroxide respectively. The amount of the basic oxide added is sufficient to raise the pH value of the pulp stock to above 12.5, preferably above 13, and to maintain the pH value of the pulp stock above 12.5, preferably above 13, for at least 60 minutes.

In some embodiments, the basic oxide is added to the pulp stock in solid form.

In some embodiments, the basic oxide is added in an amount of 1-20 g per liter of pulp stock, preferably 3-15 g per liter of pulp stock, and more preferably 5-10 g per liter of pulp stock.

In some embodiments, the preceding claims, wherein the basic oxide is CaO.

The pulp stock is preferably subjected to intensive mixing to disintegrate fiber flocs during and/or after the addition of the basic oxide. The intensity of the mixing should be sufficient in order to disintegrate fiber flocs present or formed in the pulp stock. The intensive mixing to disintegrate fiber flocs may for example be achieved using a pulper, a refiner, a paddle mixer, a rotor mixer, and a centrifugal pump. The intensive mixing to disintegrate fiber flocs ensures good contact between microbial contaminants present in the pulp stock, and the added basic oxide.

The reaction of the basic oxide with water is exothermic and thus, in some embodiments, the addition of the basic oxide increases the temperature of the pulp stock.

In some embodiments, the organic oxidative acid is peracetic acid (PAA) or a combination of PAA, acetic acid and hydrogen peroxide. In a preferred embodiment the organic oxidative acid is peracetic acid (PAA).

In some embodiments, the organic oxidative acid is added to the pulp stock in the form of an aqueous solution.

In some embodiments, the organic oxidative acid is added in an amount of 0.1-10 g per liter of pulp stock, and preferably in an amount of 0.1-5 g per liter of pulp stock.

PAA is typically added in the form of an aqueous solution having a consistency of 5-50 wt %, preferably 10-40 wt %, and more preferably 15-30 wt % PAA. The aqueous solution of PAA is typically added in a volume of 1-50 ml per liter of pulp stock, preferably in a volume of 2-30 ml per liter of pulp stock, and more preferably in a volume of 3-10 ml per liter of pulp stock.

In some embodiments, the amount of the organic oxidative acid added is sufficient to reduce the pH value of the pulp stock to in the range of 6 to 8.

The pulp stock is preferably subjected to intensive mixing to disintegrate fiber flocs during and/or after the addition of the organic oxidative acid. The intensity of the mixing should be sufficient in order to disintegrate fiber flocs present or formed in the pulp stock. The intensive mixing to disintegrate fiber flocs may for example be achieved using a pulper, a refiner, a paddle mixer, a rotor mixer, and a centrifugal pump. The intensive mixing to disintegrate fiber flocs ensures good contact between microbial contaminants present in the pulp stock, and the added organic oxidative acid.

In some embodiments, the treated pulp stock is further washed and/or dewatered to a desired consistency.

The treated pulp stock obtained according to the inventive method is preferably suitable for demanding end uses such as for direct or indirect food contact.

The inventive method typically increases the redox potential value of the treated pulp stock. The treated pulp stock will typically have a positive redox potential value. In some embodiments, the treated pulp stock after step d) has a redox potential value above +100 mV, preferably above +200 mV.

The inventive method significantly decreases the enzymatic activity of the treated pulp stock as compared to the untreated pulp stock provided in step a). In some embodiments, the treated pulp stock after step d) has an enzymatic activity measured by RLU (relative luminescence units) below 10 000, preferably below 1000, and more preferably below 500.

Accordingly, the inventive method also significantly decreases the microbial equivalent content of the treated pulp stock as compared to the untreated pulp stock provided in step a). In some embodiments, the treated pulp stock after step d) has a microbial equivalent content of below 1×10⁵ ME/ml.

The decrease in microbial activity in the treated pulp stock may also be seen in a decrease in the total colony forming unit count of the treated pulp stock. In some embodiments, the treated pulp stock after step d) has a total colony forming unit count of below 50 000 CFU/ml, preferably below 40 000 CFU/ml.

In some embodiments, the method also reduces the odor of the pulp stock.

The method has been found to not only lead to a sufficient reduction of the load of microbial contaminants in a pulp stock comprising a recycled fiber fraction, but also to do so while maintaining the mechanical properties of paperboard prepared from the treated pulp stock at an acceptable level. Specifically, it has been found that with the inventive method, the load of microbial contaminants can be significantly reduced, while the elastic modulus, the tensile strength index, the TEA index, and/or the tensile stiffness index of isotropic sheets formed from the treated pulp stock is substantially retained. Isotropic sheets are prepared according to the standard SCAN-CM 26:99.

Preferably, the elastic modulus of an isotropic sheet formed from the treated pulp stock is at least 85%, preferably at least 90%, of the elastic modulus of a corresponding isotropic sheet formed from the pulp stock prior to treatment with the basic oxide and organic oxidative acid. In some embodiments, an isotropic sheet formed from the treated pulp stock after step d) has an elastic modulus of at least 1.5 GPa, preferably at least 1.8 GPa.

Preferably, the tensile strength index of an isotropic sheet formed from the treated pulp stock is at least 85%, preferably at least 90%, of the tensile strength index of a corresponding isotropic sheet formed from the pulp stock prior to treatment with the basic oxide and organic oxidative acid. In some embodiments, an isotropic sheet formed from the treated pulp stock after step d) has a tensile strength index of at least 24 Nm/g, preferably at least 28 Nm/g.

Preferably, the TEA index of an isotropic sheet formed from the treated pulp stock is at least 85%, preferably at least 90%, of the TEA index of a corresponding isotropic sheet formed from the pulp stock prior to treatment with the basic oxide and organic oxidative acid. In some embodiments, an isotropic sheet formed from the treated pulp stock after step d) has a TEA index of at least 0.6 J/g, preferably at least 0.7 J/g.

Preferably, the tensile stiffness index of an isotropic sheet formed from the treated pulp stock is at least 85%, preferably at least 90%, of the tensile stiffness index of a corresponding isotropic sheet formed from the pulp stock prior to treatment with the basic oxide and organic oxidative acid. In some embodiments, an isotropic sheet formed from the treated pulp stock after step d) has a tensile stiffness index of at least 3 kNm/g, preferably at least 3.5 kNm/g.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention should not be limited to the particular embodiment disclosed as the best mode contemplated for carrying out this invention, but that the invention will include all embodiments falling within the scope of the appended claims.

### EXAMPLES

A pulp stock comprising recycled fiber fraction obtained from collected post-consumer UBC starting material was dewatered to a consistency of 3 wt %. The pH value of the pulp stock was about 5. The redox potential of the pulp stock was about −250 mV. To the dewatered pulp stock, solid calcium oxide (CaO) was added in an amount of 8 g per liter. The CaO addition raised the pH of the pulp stock to 12.5. The pulp stock was subjected to intensive mixing in a rotor mixer to disintegrate fiber flocs and allowed to remain at the raised pH for 60 minutes. The pH of the pulp stock at the end of the 60 minutes was still 12.5. Then, a 15 wt % aqueous solution of peracetic acid (PAA) was added to the pulp stock in an amount of 3 ml per liter. The pulp stock was subjected to intensive mixing in a rotor mixer to disintegrate fiber flocs. The PAA addition reduced the pH of the pulp stock to just below 10. Further pH reduction down to 7 was then obtained by addition of sulfuric acid (about 5 ml/l). The redox potential of the treated pulp stock was about +300 mV.

Standard isotropic sheets were prepared according to SCAN-CM 26:99 from the untreated and the treated pulp stocks.

Enzymatic activity (measured by RLU, relative luminescence units) and microbial equivalent content (ME/ml), and microbial count (CFU/ml) were measured on the untreated and treated pulp stock, and the standard sheet formed from treated pulp stock, respectively, and the smell of the pulp stocks was assessed. The results are presented in Table 1. Enzymatic activity and microbial count drop dramatically as a result of the treatment, and bad smell disappears:

TABLE 1

| | | Microbial | Total colony | |
|---|---|---|---|---|
| | Enzymatic | equivalent | forming unit | |
| | activity | content | count | |
| | (RLU) | (ME/ml) | (CFU/ml) | Smell |
| Untreated pulp stock | 760 000 | 6.33E+07 | 8.70E+06 | Strong, |
| | | | | bad |
| Treated pulp stock | 200 | 1.58E+04 | 4.50E+03 | Mild, |
| | | | | acidic |
| Standard sheet after | 40 | 3.34E+03 | 980 | — |
| treatment | | | | |

Also, it was found that with the inventive method, Bacillus cereus and Escherichia coli, intestinal bacteria that cause diseases and food poisoning, can be completely eliminated. Bacterial counts on based on Standard sheets (20 cm²) are presented in Table 2.

TABLE 2

| | E. coli count | Bacillus cereus count |
|---|---|---|
| Untreated pulp stock | 98 | 7 |
| Treated pulp stock | 0 | 0 |

The treatment did not decrease the strength properties of isotropic sheets prepared from the treated pulp stock as compared to isotropic sheets prepared from the untreated pulp stock. Elementary strength properties measured from the isotropic sheets are somewhat lower than those of virgin unrefined kraft fibers, but still good. The standard sheet after treatment exhibited the following strength/mechanical properties:

| | | |
|---|---|---|
| Elastic modulus (ISO 1924-3: 2005) | 2 | GPa |
| Tensile strength index (ISO 1924-3: 2005) | 30 | Nm/g |
| TEA index (ISO 1924-3: 2005) | 0.8 | J/g |
| Tensile stiffness index (ISO 1924-3: 2005) | 4 | kNm/g |

1. A method for reducing a load of microbial contaminants in a pulp stock comprising a recycled fiber fraction, said method comprising the following steps performed in sequence:
a) providing a pulp stock comprising a recycled fiber fraction at a consistency in a range of 2-10 wt % in water;
b) adding a basic oxide selected from a group consisting of calcium oxide (CaO) and sodium oxide (Na₂O) to the pulp stock and allowing the basic oxide to react with water to form a corresponding hydroxide, wherein an amount of the basic oxide added is sufficient to raise a pH value of the pulp stock to above 12.5 and to maintain the pH value of the pulp stock above 12.5 for at least 60 minutes;
c) allowing the pulp stock to remain at a pH value above 12.5 for at least 60 minutes; and
d) adding an organic oxidative acid to the pulp stock to provide a treated pulp stock, wherein an amount of the organic oxidative acid added is sufficient to reduce the pH value of the treated pulp stock to below 10.

2. The method according to claim 1, wherein the recycled fiber fraction comprises fibers obtained from used beverage carton (UBC).

3. The method according to claim 1, wherein the recycled fiber fraction comprises at least 70 wt % cellulose fiber, based on a dry weight.

4. The method according to claim 1, wherein the pulp stock in step a) has a pH value below 7.

5. The method according to claim 1, wherein the pulp stock in step a) has a redox potential value below −100 mV.

6. The method according to claim 1, wherein the pulp stock in step a) has an enzymatic activity measured by RLU (relative luminescence units) above 100,000.

7. The method according to claim 1, wherein the pulp stock in step a) has a microbial equivalent content of above 1×10⁶ ME/ml.

8. The method according to claim 1, wherein the pulp stock in step a) has a total colony forming unit count of above 60,000 CFU/ml.

9. The method according to claim 1, wherein the basic oxide is added to the pulp stock in solid form.

10. The method according to claim 1, wherein the amount of basic oxide added is between 1-20 g per liter of pulp stock.

11. The method according to claim 1, wherein the basic oxide is CaO.

12. The method according to claim 1, wherein the addition of the basic oxide increases a temperature of the pulp stock.

13. The method according to claim 1, wherein the organic oxidative acid is peracetic acid (PAA) or a combination of PAA, acetic acid, and hydrogen peroxide.

14. The method according to claim 1, wherein the organic oxidative acid is added to the pulp stock as an aqueous solution.

15. The method according to claim 1, wherein the amount of organic oxidative acid added is between 0.1-10 g per liter of pulp stock.

16. The method according to claim 1, wherein the amount of organic oxidative acid added is sufficient to reduce the pH value of the pulp stock to between 6 to 8.

17. The method according to claim 1, wherein the treated pulp stock after step d) has a redox potential value above +100 mV.

18. The method according to claim 1, wherein the treated pulp stock after step d) has an enzymatic activity measured by RLU (relative luminescence units) below 10,000.

19. The method according to claim 1, wherein the treated pulp stock after step d) has a microbial equivalent content of below 1×10⁵ ME/ml.

20. The method according to claim 1, wherein the treated pulp stock after step d) has a total colony forming unit count of below 50,000 CFU/ml.

21. The method according to claim 1, wherein the method reduces an odor of the pulp stock.

22. The method according to claim 1, wherein an isotropic sheet formed from the treated pulp stock after step d) has an elastic modulus of at least 1.5 GPa, as measured according to ISO 1924-3:2005.

23. The method according to claim 1, wherein an isotropic sheet formed from the treated pulp stock after step d) has a tensile strength index of at least 24 Nm/g, as measured according to ISO 1924-3:2005.

24. The method according to claim 1, wherein an isotropic sheet formed from the treated pulp stock after step d) has a TEA index of at least 0.6 J/g, as measured according to ISO 1924-3:2005.

25. The method according to claim 1, wherein an isotropic sheet formed from the treated pulp stock after step d) has a tensile stiffness index of at least 3 kNm/g, as measured according to ISO 1924-3:2005.
